(19) United States
(12) Patent Application Publication
(10) Pub. No.: US 2025/0028222 A1
(43) Pub. Date: Jan. 23, 2025

(54) CASCADABLE PHOTONIC CIRCUIT WITH SEMICONDUCTOR OPTICAL AMPLIFIER BASED AMPLITUDE THRESHOLDER

(71) Applicant: Milkshake Technology Inc., Kingston (CA)

(72) Inventors: Bicky A. Marquez, Ontario (CA); Joshua Baxter, Ontario (CA); Alireza Samani, Ontario (CA); Ahmed Khaled, Ontario (CA); Bhavin J. Shastri, Ontario (CA); Douglas H. Wightman, Ontario (CA)

(21) Appl. No.: 18/446,865

(22) Filed: Aug. 9, 2023

Related U.S. Application Data
(63) Continuation-in-part of application No. 18/225,032, filed on Jul. 21, 2023.

(51) Int. Cl. G02F 3/00

(52) U.S. Cl. CPC G02F 3/00

(57) ABSTRACT

A photonic circuit with at least one semiconductor optical amplifier-based amplitude thresholder for correcting bit errors. The photonic circuit further includes a first cascaded series of one or more photonic components and a second cascaded series of one or more photonic components that is coupled to the at least one amplitude thresholder. The first cascaded series of one or more photonic components generates one or more intermediate photonic output signals based on one or more received photonic input signals. The at least one amplitude thresholder generates one or more thresholding photonic signals based on a first of the one or more photonic output signals. The second cascaded series of one or more photonic components generates one or more photonic output signals based at least in part on a second of the one or more intermediate photonic output signals and the one or more thresholding photonic signals.

### CROSS-REFERENCE TO RELATED APPLICATIONS

This application is a continuation-in-part of co-pending U.S. patent application Ser. No. 18/225,032, filed Jul. 21, 2023, which is hereby incorporated by reference in its entirety.

### TECHNICAL FIELD

The present disclosure generally relates to a processor architecture and, more specifically, to a cascadable photonic circuit with a semiconductor optical amplifier-based amplitude thresholder.

### BACKGROUND

Photonic hardware is favorable for applications requiring high bandwidth, low latency, and low switching energy for signal processing, data communications, and information processing (i.e., computing). Recent innovations in silicon photonic fabrication have enabled the on-chip implementation of photonic circuits. This has opened a low-cost, high-precision, and scalable avenue for the development of photonic computing. Advances in photonic computing have demonstrated suitability for applications requiring high-bandwidth parallel processing, especially neural networks, offering higher speed and less energy consumption than equivalent networks implemented in digital or analog electronics.

Circuitry for photonic computing typically employs cascaded photonic gates. Different phases of optical signals (i.e., light signals) processed by a photonic gate can cause amplitude errors and/or phase errors at an output of the photonic gate. Furthermore, these amplitude errors and/or phase errors can propagate and accumulate through photonic circuitry that includes cascaded photonic gates.

### SUMMARY

Embodiments of the present disclosure are directed to the implementation of a photonic circuit that utilizes at least one (i.e., one or more) nonlinear semiconductor optical amplifier (SOA) based amplitude thresholder for correction of amplitude errors and/or phase errors produced by photonic logic. The photonic circuit comprises one or more (i.e., at least one) photonic inputs configured to receive one or more photonic input signals, a first cascaded series of one or more photonic components coupled to the one or more photonic inputs, at least one amplitude thresholder coupled to the first cascaded series of one or more photonic components, and a second cascaded series of one or more photonic components coupled to the first cascaded series of one or more photonic components and the at least one amplitude thresholder. The first cascaded series of one or more photonic components is configured to generate one or more intermediate photonic output signals based on the one or more photonic input signals. The at least one amplitude thresholder is configured to generate one or more thresholding photonic signals by saturating one or more amplitudes of a first of the one or more intermediate photonic output signals when the at least one amplitude thresholder operates in a first operating regime. The second cascaded series of one or more photonic components is configured to generate one or more photonic output signals based at least in part on a second of the one or more intermediate photonic output signals and the one or more thresholding photonic signals.

Embodiments of the present disclosure are further directed to a non-transitory computer-readable storage medium comprising stored instructions that, when executed by at least one processor, cause the at least one processor to: instruct one or more photonic inputs of a photonic circuit to receive one or more photonic input signals; instruct a first cascaded series of one or more photonic components of the photonic circuit coupled to the one or more photonic inputs to generate one or more intermediate photonic output signals based on the one or more photonic input signals; instruct at least one amplitude thresholder of the photonic circuit coupled to the first cascaded series of one or more photonic components to generate one or more thresholding photonic signals by saturating one or more amplitudes of a first of the one or more intermediate photonic output signals when the at least one amplitude thresholder operates in a first operating regime; and instruct a second cascaded series of one or more photonic components of the photonic circuit coupled to the first cascaded series of one or more photonic components and the at least one amplitude thresholder to generate one or more photonic output signal based at least in part on a second of the one or more intermediate photonic output signals and the one or more thresholding photonic signals. The non-transitory computer-readable storage medium can be a digital storage medium, an analog storage medium, an optical storage medium, some other type of storage medium, or some combination thereof. The at least one processor can be an optical processor, an electronic processor (e.g., central processing unit (CPU) processor, machine learning (ML) processor, graphics processing unit (GPU) processor), some other type of processor, or some combination thereof.

Embodiments of the present disclosure are further directed to a method for operating a photonic circuit that utilizes at least one nonlinear SOA-based amplitude thresholder for correction of amplitude errors and/or phase errors produced by photonic logic. The method comprises: receiving, at one or more photonic inputs of the photonic circuit, one or more photonic input signals; generating, by a first cascaded series of one or more photonic components of the photonic circuit coupled to the one or more photonic inputs, one or more intermediate photonic output signals based on the one or more photonic input signals; generating, by at least one amplitude thresholder of the photonic circuit coupled to the first cascaded series of one or more photonic components, one or more thresholding photonic signals by saturating one or more amplitudes of a first of the one or more intermediate photonic output signals when the at least one amplitude thresholder operates in a first operating regime; and generating, by a second cascaded series of one or more photonic components of the photonic circuit coupled to the first cascaded series of one or more photonic components and the at least one amplitude thresholder, one or more photonic output signals based at least in part on a second of the one or more intermediate photonic output signals and the one or more thresholding photonic signals.

### BRIEF DESCRIPTION OF THE DRAWINGS

Figure (FIG. 1 illustrates an example cascadable photonic circuit that includes at least one nonlinear semiconductor optical amplifier (SOA) based amplitude thresholder, in accordance with some embodiments.

FIG. 2A illustrates an example graph of transfer functions of a nonlinear SOA-based amplitude thresholder, in accordance with some embodiments.

FIG. 2B illustrates an example generalized graph of a transfer function of a nonlinear SOA-based amplitude thresholder represented as a piece-wise function, in accordance with some embodiments.

FIG. 3A illustrates an example XOR logic operation of the cascadable photonic circuit in FIG. 1, in accordance with some embodiments.

FIG. 3B illustrates an example graph of a transfer function of a nonlinear SOA-based amplitude thresholder for the XOR logic operation in FIG. 3A, in accordance with some embodiments.

FIG. 3C illustrates another example graph of a transfer function of a nonlinear SOA-based amplitude thresholder for the XOR logic operation in FIG. 3A, in accordance with some embodiments.

FIG. 4 is a flowchart illustrating an example method for operating a photonic circuit with at least one nonlinear SOA-based amplitude thresholder, in accordance with some embodiments.

The figures depict embodiments of the present disclosure for purposes of illustration only. One skilled in the art will readily recognize from the following description that alternative embodiments of the structures and methods illustrated herein can be employed without departing from the principles or benefits touted by the disclosure described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that can be employed without departing from the principles of what is claimed.

Reference will now be made in detail to several embodiments, examples of which are illustrated in the accompanying figures. It is noted that wherever practicable, similar or like reference numbers can be used in the figures and can indicate similar or like functionality. The figures depict embodiments of the disclosed system (or method) for illustration only. One skilled in the art will readily recognize from the following description that alternative embodiments of the structures and methods illustrated herein can be employed without departing from the principles described herein.

Embodiments of the present disclosure are directed to the implementation of a cascadable photonic circuit (i.e., photonic logic gate) that utilizes at least one (i.e., one or more) nonlinear semiconductor optical amplifier (SOA) based amplitude thresholder to correct errors (e.g., amplitude errors and/or phase errors) produced by a passive and/or active linear photonic logic within the photonic circuit. A photonic logic gate (e.g., exclusive ‘OR’ (XOR) photonic gate) presented herein utilizes the at least one nonlinear SOA-based amplitude thresholder as a nonlinear photonic component for correction of amplitude errors and/or phase errors produced by the passive and/or active linear photonic logic. A cascadable XOR photonic gate presented in this disclosure is implemented by utilizing a beam splitter, photonic combiners, a phase shifter, one or more (i.e., at least one) photonic attenuators/linear amplifiers, and at least one nonlinear SOA-based amplitude thresholder that can operate in different operating regimes. The XOR photonic gate presented herein produces correct output results without any errors and can be directly cascaded with other photonic gates within a photonic processor.

### Cascadable Photonic Circuit

Figure (FIG. 1 illustrates an example cascadable photonic circuit 100 that includes at least one nonlinear amplitude thresholder, in accordance with some embodiments. The photonic circuit 100 may include a photonic combiner 106, a beam splitter 110 coupled to an output port of the photonic combiner 106, a photonic attenuator/linear amplifier 116 coupled to a first output port of the beam splitter 110, a semiconductor optical amplifier (SOA) based amplitude thresholder 118 coupled to a second output port of the beam splitter 110, a phase shifter 124 coupled to an output port of the photonic attenuator/linear amplifier 116, a photonic attenuator 126 coupled to an output port of the SOA-based amplitude thresholder 118, and a photonic combiner 132 coupled to an output port of the phase shifter 124 and an output port of the photonic attenuator 126. The photonic circuit 100 may generate a photonic output signal 134 as a logical function of photonic input signals 102, 104 (and, optionally, one or more additional photonic input signals). The photonic circuit 100 may be configured to operate as a nonlinear XOR photonic gate. Alternatively, or additionally, the photonic circuit 100 may be configured to operate as some other nonlinear photonic logic gate. The nonlinearity in the photonic circuit 100 may enable error-free cascadability of the photonic circuit 100 with other linear or nonlinear photonic gates. The photonic circuit 100 may include fewer or additional components not shown in FIG. 1 such as, but not limited to, additional phase shifters for compensation of fabrication variations, linear photonic amplifiers, and/or photonic attenuators.

The photonic combiner 106 may receive a pair of photonic input signals 102, 104 and generate a photonic signal 108 that represents a logical combination of the photonic input signals 102 and 104. Thus, the photonic combiner 106 may operate as a linear OR photonic logic gate. The photonic input signals 102, 104 may be light signals of corresponding input amplitudes (that each corresponds to logical “1” or logical “0”), corresponding input phases and/or corresponding input modes (i.e., input light spatial distribution and/or input wavelengths) injected into a set of input ports of the photonic combiner 106. The photonic input signals 102, 104 may be generated by an array of lasers (not shown in FIG. 1). The array of lasers may be instructed (i.e., triggered) by at least one processor (e.g., optical processor, electronic processor, electro-optical processor, etc.) coupled to the array of lasers to generate the photonic input signals 102, 104 of specific amplitudes, phases and/or modes (or wavelengths). The set of input ports of the photonic combiner 106 may represent, e.g., a set of waveguides, a set of waveguide polarizations, a set of waveguide modes, a set of light wavelengths, etc. The photonic signal 108 may be a light signal of corresponding output amplitudes (that each corresponds to logical “1” or logical “0”), corresponding output phase and/or corresponding output mode (i.e., output light spatial distribution and/or output wavelength) detected at an output port of the photonic combiner 106. The output port of the photonic combiner 106 may represent, e.g., a waveguide, a waveguide polarization, a waveguide mode, a light wavelength, a signal radiated by the photonic combiner 106, etc. The photonic combiner 106 may pass the photonic signal 108 to the beam splitter 110.

The beam splitter 110 may receive the photonic signal 108 at its input port. The input port of the beam splitter 110 may represent, e.g., a waveguide, a waveguide polarization, a waveguide mode, a light wavelength, etc. The beam splitter 110 is a linear photonic component that splits the received photonic signal 108 into two photonic signals 112, 114 representing components of the received photonic signal 108. Each photonic signal 112, 114 may be output at a respective output port of the beam splitter 110. A set of output ports of the beam splitter 110 may represent, e.g., a set of waveguides, a set of waveguide polarizations, a set of waveguide modes, a set of light wavelengths, signals radiated by the beam splitter 110, etc. The beam splitter 110 may pass the photonic signals 112 and 114 to the photonic attenuator/linear amplifier 116 and the SOA-based amplitude thresholder 118, respectively.

The photonic attenuator/linear amplifier 116 may receive the photonic signal 112 at its input port. The input port of the photonic attenuator/linear amplifier 116 may represent, e.g., a waveguide, a waveguide polarization, a waveguide mode, a light wavelength, etc. The photonic attenuator/linear amplifier 116 is a linear photonic component that generates a photonic signal 120 by attenuating (or amplifying) amplitudes of the received photonic signal 112. The attenuated/amplified photonic signal 120 may be output at an output port of the photonic attenuator/linear amplifier 116. The output port of the photonic attenuator/linear amplifier 116 may represent, e.g., a waveguide, a waveguide polarization, a waveguide mode, a light wavelength, a signal radiated by the photonic attenuator/linear amplifier 116, etc. The photonic attenuator/linear amplifier 116 may pass the attenuated/amplified photonic signal 120 to the phase shifter 124.

The phase shifter 124 may receive the attenuated/amplified photonic signal 120 at its input port. The input port of the phase shifter 124 may represent, e.g., a waveguide, a waveguide polarization, a waveguide mode, a light wavelength, etc. The phase shifter 124 is a linear photonic component that generates a photonic signal 128 by shifting a phase of the received attenuated/amplified photonic signal 120. For example, the phase shifter 124 may apply a phase shift of π radians to the attenuated/amplified photonic signal 120, i.e., the photonic signal 128 may represent an inverted version of the attenuated/amplified photonic signal 120. The phase-shifted photonic signal 128 may be output at an output port of the phase shifter 124. The output port of the phase shifter 124 may represent, e.g., a waveguide, a waveguide polarization, a waveguide mode, a light wavelength, a signal radiated by the phase shifter 124, etc. The phase shifter 124 may pass the phase-shifted photonic signal 128 to the photonic combiner 132.

The SOA-based amplitude thresholder 118 may receive the photonic signal 114 at its input port. The input port of the SOA-based amplitude thresholder 118 may represent, e.g., a waveguide, a waveguide polarization, a waveguide mode, a light wavelength, etc. The SOA-based amplitude thresholder 118 may be an active nonlinear photonic amplifier that generates a photonic signal 122 by saturating an amplitude of the photonic signal 114 to a defined amplitude level (e.g., above zero amplitude level) while being configured to operate in a first region of a transfer function of the SOA-based amplitude thresholder. Or the SOA-based amplitude thresholder 118 may operate in a second region of the transfer function (e.g., for amplitudes of the photonic signal 114 smaller than a first input threshold level) and generate the photonic signal 122 by applying a gain of the second region to an amplitude of the photonic signal 114. The SOA-based amplitude thresholder 118 may operate in the first region or in the second region depending on an amplitude level of the photonic signal 114. In one or more embodiments, for some values of amplitudes of the photonic signal 114 (e.g., smaller than a second input threshold level that is less than the first input threshold level), the SOA-based amplitude thresholder 118 may operate in a third region of the transfer function different than the first and second regions and generate the photonic signal 122 by saturating an amplitude of the photonic signal 114 to another defined amplitude level (e.g., zero (or substantially zero) amplitude level).

The photonic signal 122 generated by the SOA-based amplitude thresholder 118 may be output at an output port of the SOA-based amplitude thresholder 118. The output port of the SOA-based amplitude thresholder 118 may represent, e.g., a waveguide, a waveguide polarization, a waveguide mode, a light wavelength, a signal radiated by the SOA-based amplitude thresholder 118, etc. The SOA-based amplitude thresholder 118 may pass the photonic signal 122 to the photonic attenuator 126.

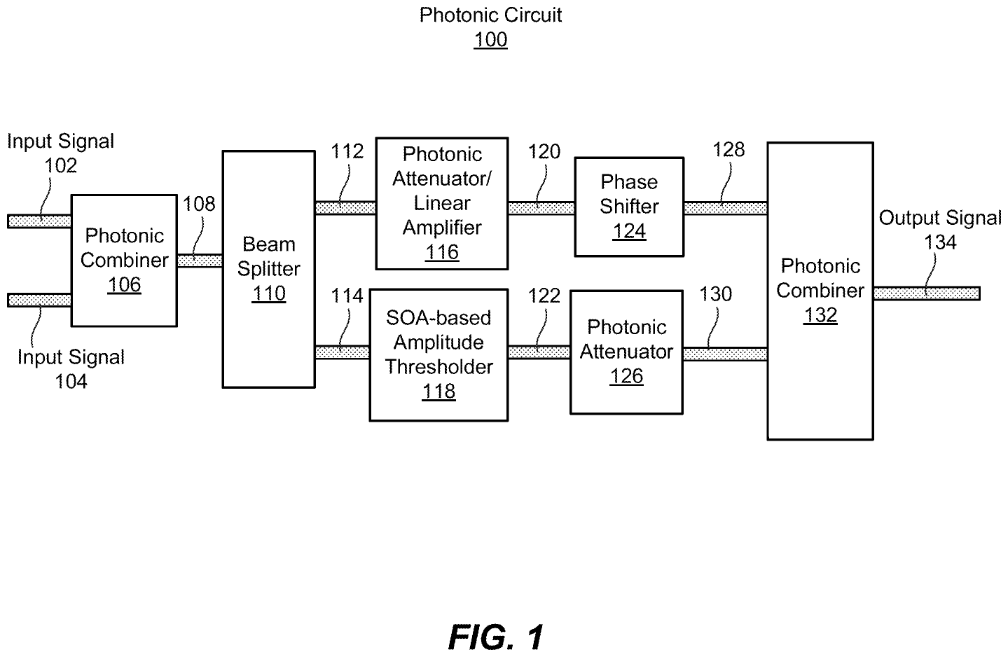

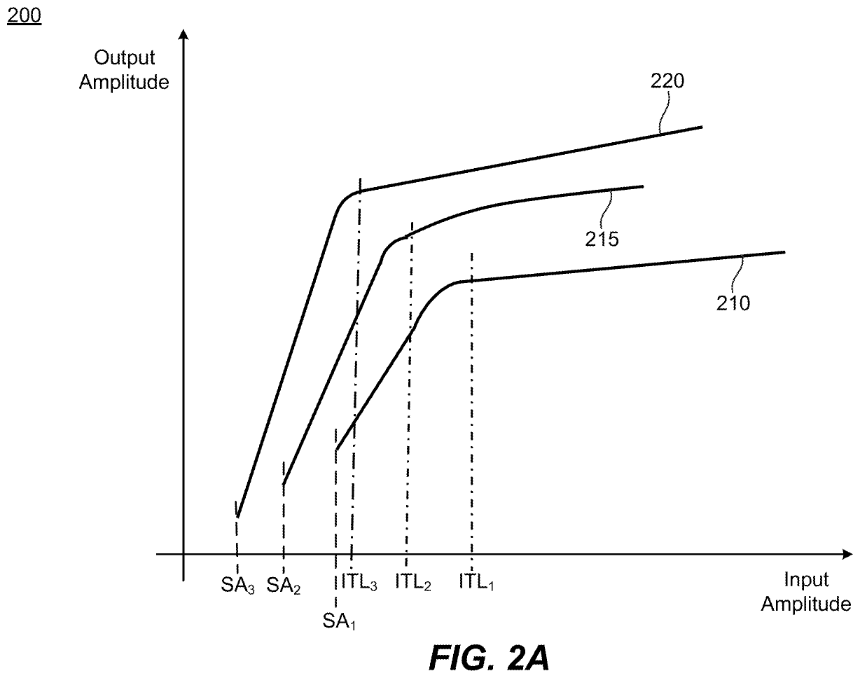

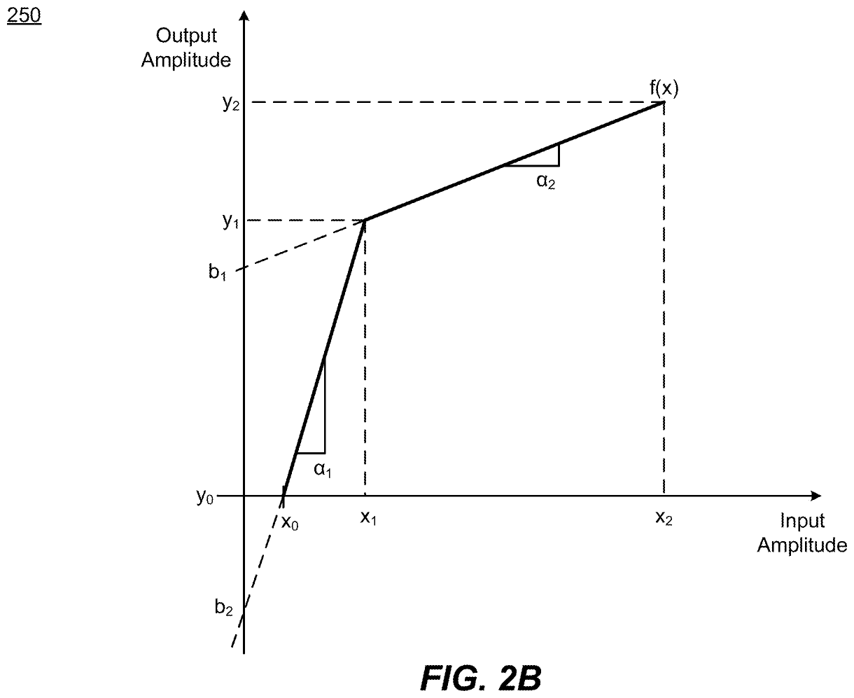

FIG. 2A illustrates an example graph 200 of transfer functions of the SOA-based amplitude thresholder 118, in accordance with some embodiments. A transfer function of the SOA-based amplitude thresholder 118 represents a function that determines an “output amplitude” of the photonic signal 122 based on an “input amplitude” of the photonic signal 114. The example graph 200 shows plots 210, 215 and 220 each representing a different transfer function of the SOA-based amplitude thresholder 118, i.e., the SOA-based amplitude thresholder 118 may be configured to operate in accordance with the transfer function 210, the transfer function 215 or the transfer function 220.

When the SOA-based amplitude thresholder 118 is configured to operate in accordance with the transfer function 210, the SOA-based amplitude thresholder 118 operates in a first region of the transfer function 210 for an “input amplitude” of the photonic signal 114 that is smaller than a first input threshold level (“ITL₁” in FIG. 2A), and the SOA-based amplitude thresholder 118 operates in a second region of the transfer function 210 for an “input amplitude” of the photonic signal 114 that is equal to or greater than the first threshold level, ITL1. When the SOA-based amplitude thresholder 118 is configured to operate in accordance with the transfer function 215, the SOA-based amplitude thresholder 118 operates in a first region of the transfer function 215 for an “input amplitude” of the photonic signal 114 that is smaller than a second input threshold level (“ITL₂” in FIG. 2A), and the SOA-based amplitude thresholder 118 operates in a second region of the transfer function 215 for an “input amplitude” of the photonic signal 114 that is equal to or greater than the second threshold level, ITL₂. When the SOA-based amplitude thresholder 118 is configured to operate in accordance with the transfer function 220, the SOA-based amplitude thresholder 118 operates in a first region of the transfer function 220 for an “input amplitude” of the photonic signal 114 that is smaller than a third input threshold level (“ITL₃” in FIG. 2A), and the SOA-based amplitude thresholder 118 operates in a second region of the transfer function 220 for an “input amplitude” of the photonic signal 114 that is equal to or greater than the third threshold level, ITL₃. In some embodiments, the first region of each transfer function 210, 215, 220 is approximately a linear region, and the second region of each transfer function 210, 215, 220 is approximately a nonlinear region.

A slope of the first region of each transfer function 210, 215 and 220 may be different. Also, a slope of the second region of each transfer function 210, 215 and 220 may be different and may not be a straight line. Furthermore, each transfer function 210, 215 and 220 may have a different starting amplitude (“SA”) representing a minimum input amplitude level for which the SOA-based amplitude thresholder 118 is configured to operate. As shown in FIG. 2A, a starting amplitude for the transfer function 210 is SA₁, a starting amplitude for the transfer function 215 is SA₂, and a starting amplitude for the transfer function 220 is SA₃. A different starting amplitude for each transfer function 210, 215, 220 may produce a different starting output amplitude for each transfer function 210, 215, 220.

Additionally, a “knee” of each transfer function 210, 215 and 220 may be different, which leads to a different intensity of compression in the second region of each transfer function 210, 215 and 220. The different intensity of compression in the second region for each transfer function 210, 215 and 220 (as well as different slopes of first regions and different starting amplitudes) may further lead to a different saturation level of an “output amplitude” of the photonic signal 122 produced by the SOA-based amplitude thresholder 118 when operating in the second region. For example, the transfer function 210 may be associated with a first saturation level (e.g., 0.3) for the “output amplitude”, the transfer function 215 may be associated with a second saturation level (e.g., 0.5) for the “output amplitude” that is greater than the first saturation level, and the transfer function 220 may be associated with a third saturation level (e.g., 1.0) for the “output amplitude” that is greater than the second saturation level.

The SOA-based amplitude thresholder 118 may be tuned to operate in accordance with a particular transfer function 210, 215, 220 that is associated with a respective saturation level for the “output amplitude”. Thus, when the SOA-based amplitude thresholder 118 is tuned to operate in accordance with the transfer function 210 and the “input amplitude” of the photonic signal 114 is greater than the first input threshold level, ITL₁, the “output amplitude” of the photonic signal 122 equals to the first saturation level. Similarly, when the SOA-based amplitude thresholder 118 is tuned to operate in accordance with the transfer function 215 and the “input amplitude” of the photonic signal 114 is greater than the second input threshold level, ITL₂, the “output amplitude” of the photonic signal 122 equals to the second saturation level. When the SOA-based amplitude thresholder 118 is tuned to operate in accordance with the transfer function 220 and the “input amplitude” of the photonic signal 114 is greater than the third input threshold level, ITL₃, the “output amplitude” of the photonic signal 122 equals to the third saturation level.

When the SOA-based amplitude thresholder 118 is tuned to operate in accordance with the transfer function 210 and the “input amplitude” of the photonic signal 114 is below the first input threshold level, ITL₁, the “input amplitude” of the photonic signal 114 may be processed by the first region of the transfer function 210. In such a case, an amplitude of the photonic signal 122 generated by the SOA-based amplitude thresholder 118 may not be saturated but instead proportional to a first gain level that the SOA-based amplitude thresholder 118 achieves when operating in the first region of the transfer function 210 (e.g., slope of the first region of the transfer function 210). When the SOA-based amplitude thresholder 118 is tuned to operate in accordance with the transfer function 215 and the “input amplitude” of the photonic signal 114 is below the second input threshold level, ITL₂, the “input amplitude” of the photonic signal 114 may be processed by the first region of the transfer function 215. In such a case, an amplitude of the photonic signal 122 generated by the SOA-based amplitude thresholder 118 may not be saturated but instead proportional to a second gain level that the SOA-based amplitude thresholder 118 achieves when operating in the first region of the transfer function 215 (e.g., slope of the first region of the transfer function 215). When the SOA-based amplitude thresholder 118 is tuned to operate in accordance with the transfer function 220 and the “input amplitude” of the photonic signal 114 is below the third input threshold level, ITL₃, the “input amplitude” of the photonic signal 114 may be processed by the first region of the transfer function 220. In such a case, an amplitude of the photonic signal 122 generated by the SOA-based amplitude thresholder 118 may not be saturated but instead proportional to a third gain level that the SOA-based amplitude thresholder 118 achieves when operating in the first region of the transfer function 220 (e.g., slope of the first region of the transfer function 220).

In one or more embodiments, the SOA-based amplitude thresholder 118 is tuned to operate in accordance with a particular transfer function 210, 215, 220, each associated with one or more different value of parameters in the nonlinear model of the SOA-based amplitude thresholder 118. In general, one or more parameters of photonic components in the photonic circuit 100 (e.g., attenuation levels of the photonic attenuator/linear amplifier 116 and the photonic attenuator 126) may be set such that to accommodate a particular transfer function 210, 215, 220 of the SOA-based amplitude thresholder 118. For an accurate operation of the photonic circuit 100 (e.g., XOR logic operation), the SOA-based amplitude thresholder 118 may be tuned to operate in accordance with a particular transfer function 210, 215, 220 such that “saturated amplitudes” of the photonic signal 122 are matched with “un-saturated amplitudes” of the photonic signal 120.

FIG. 2B illustrates an example generalized graph 250 of a transfer function of the SOA-based amplitude thresholder 118 represented as a piece-wise function, in accordance with some embodiments. The general nonlinearity of the SOA-based amplitude thresholder 118 illustrated in FIG. 2A may be approximated by a piece-wise transfer function f(x) in FIG. 2B. Hence, each transfer function 210, 215, 220 in FIG. 2A may be approximated by a corresponding piece-wise transfer function f(x) in FIG. 2B. The piece-wise transfer function f(x) can be also referred to as a “piece-wise sigmoid function”. Alternatively, a transfer function of the SOA-based amplitude thresholder 118 may also be represented as a smooth continuous function or a combination of the piece-wise function and the smooth continuous function.

The piece-wise transfer function f(x) has two slopes, i.e., the first slope α₁=(y₁−y₀)/(x₁−x₀) on a first interval of input amplitudes x∈[x₀, x₁], and the second slope α₂=(y₂−y₁)/(x₂−x₁) on a second interval of input amplitudes x∈(x₁, x₂]. Thus, the transfer function of the SOA-based amplitude thresholder 118 may be defined by the piece-wise transfer function f(x) given as:

$$f ( x ) = \{ \begin{matrix}{α}_{1} x + {b}_{1} & if x ∈ [ {x}_{0} , {x}_{1} ] \\ {α}_{2} x + {b}_{2} & if x ∈ [ {x}_{1} , {x}_{2} ]\end{matrix} \qquad ( 1 )$$

where the values of parameters b₁ and b₂ are defined as in FIG. 2B. The first interval of input amplitudes x∈[x₀, x₁] may define operation of the SOA-based amplitude thresholder 118 in a first operating regime (or, equivalently, in a first region of the piece-wise transfer function f(x)) and the second interval of input amplitudes x∈(x₁, x₂] may define operation of the SOA-based amplitude thresholder 118 in a second operating regime (or, equivalently, in a second region of the piece-wise transfer function f(x)). Each transfer function 210, 215, 220 can be approximated with a corresponding piece-wise transfer function f(x) defined by Eq. (1). Alternatively, the SOA-based amplitude thresholder 118 may be tuned to operate in accordance with the piece-wise transfer function f(x).

Note that, in ideal case, it holds that α₁→1 and α₂→0; however, in general, α₁>>α₂. Thus, in general, it holds that y₂≈y₁, and the output amplitude value of y₂ (or y₁) may represent a saturated output amplitude generated by the SOA-based amplitude thresholder 118 (e.g., an amplitude of the photonic signal 122) when the SOA-based amplitude thresholder 118 operates in the second operating regime. The input amplitude value x greater than or equal to x₀ and lower than x₁ may represent an input threshold level for operating the SOA-based amplitude thresholder 118 in the first operating regime. The input amplitude value of x₁ may represent an input threshold level for operating the SOA-based amplitude thresholder 118 in the second operating regime. The SOA-based amplitude thresholder 118 may operate in the second operating regime when the “input amplitude” of the photonic signal 114 is greater than the threshold level of x₁ and less than or equal to x₂, where the input amplitude value of x₂ represents a largest input amplitude value for which the SOA-based amplitude thresholder 118 is configured.

In some embodiments, the SOA-based amplitude thresholder 118 is replaced with a passive nonlinear optical amplitude thresholder. The passive nonlinear optical amplitude thresholder used within the photonic circuit 100 instead of the SOA-based amplitude thresholder 118 may be a resonator-based nonlinear optical device that translates small refractive index perturbations into large changes in light propagation. Low-intensity light may be fully or partially blocked by the passive nonlinear optical amplitude thresholder, while high-intensity light may be fully or partially propagated by the passive nonlinear optical amplitude thresholder, and vice-versa. The passive nonlinear optical amplitude thresholder may be silicon-based, e.g., made of silicon or silicon nitride, or non-silicon based. In one or more embodiments, the nonlinear optical amplitude thresholder is implemented as a ring resonator (or racetrack resonator). In one or more other embodiments, the passive nonlinear optical amplitude thresholder is implemented as a fully inverse-designed resonator. In some embodiments, the passive nonlinear optical amplitude thresholder is implemented as another form of photonic resonator.

Alternatively, the SOA-based amplitude thresholder 118 may be replaced with a nonlinear optical saturable absorber that absorbs incoming light with amplitudes above a threshold level and outputs light having a sequence of thresholded amplitudes. The nonlinear optical saturable absorber may be implemented as, e.g., a saturable absorber including based on graphene, Molybdenum disulfide (MoS2) or other 2D materials, carbon nanotube, dye, unpumped gain medium, saturable semiconductor cavity laser mirror (generally referred to as a semiconductor saturable absorber mirror, SESAM), semiconductor absorber (e.g., quantum dot, semiconductor optical amplifier (SOA), ion-implanted, reverse-biased or unpumped semiconductor, etc.), or artificial saturable absorber (e.g., Kerr lensing device, nonlinear polarization rotation device, fiber loop mirror, etc.). The nonlinear optical saturable absorber in place of the SOA-based amplitude thresholder 118 would generate the photonic signal 122 by saturating (i.e., absorbing) an amplitude of the photonic signal 114 to a threshold amplitude level (e.g., approximately equal to zero) when operating in a first operating regime, or by substantially propagating an amplitude of the photonic signal 114 when operating in a second operating regime (which depends on the amplitude of the photonic signal 114). Alternatively, the SOA-based amplitude thresholder 118 may be replaced with a cascading connection of one or more saturable absorbers and one or more SOA-based amplitude thresholders.

The photonic attenuator 126 may receive the photonic signal 122 generated by the SOA-based amplitude thresholder 118 at an input port of the photonic attenuator 126. The input port of the photonic attenuator 126 may represent, e.g., a waveguide, a waveguide polarization, a waveguide mode, a light wavelength, etc. The photonic attenuator 126 is a linear photonic component that generates a photonic signal 130 by attenuating amplitudes of the photonic signal 122 by a configurable amount. The attenuated photonic signal 130 may be output at an output port of the photonic attenuator 126. The output port of the photonic attenuator 126 may represent, e.g., a waveguide, a waveguide polarization, a waveguide mode, a light wavelength, a signal radiated by the photonic attenuator 126, etc. The photonic attenuator 126 may pass the attenuated photonic signal 130 to the photonic combiner 132.

The photonic combiner 132 may receive, at its first input port, the phase-shifted photonic signal 128 generated by the phase shifter 124. The photonic combiner 132 may further receive, at its second input port, the attenuated photonic signal 130 generated by the photonic attenuator 126. The set of input ports of the photonic combiner 132 may represent, e.g., a set of waveguides, a set of waveguide polarizations, a set of waveguide modes, a set of light wavelengths, etc. The photonic combiner 132 may generate a photonic output signal 134 by combining the phase-shifted photonic signal 128 and the attenuated photonic signal 130. Thus, the photonic combiner 132 may operate as a linear OR photonic logic gate. The photonic output signal 134 may be output at an output port of the photonic combiner 132. The output port of the photonic combiner 132 may represent, e.g., a waveguide, a waveguide polarization, a waveguide mode, a light wavelength, a signal radiated by the photonic combiner 132, etc. The output port of the photonic combiner 132 may also represent an output port of the photonic circuit 100.

In some embodiments, the photonic output signal 134 generated by the photonic combiner 132 represents a resulting light signal of the XOR logic operation between the photonic input signal 102 and the photonic input signal 104. Hence, in such cases, the photonic circuit 100 operates as a nonlinear XOR photonic logic gate. Since the photonic output signal 134 together with the photonic input signals 102 and 104 form an accurate truth table of an XOR photonic logic gate (i.e., no errors are propagated to the output port of the photonic circuit 100), the photonic circuit 100 is cascadable, i.e., the photonic circuit 100 can be directly connected with other (same or different) photonic circuits within a photonic processor.

### Example Cascadable Photonic Gate

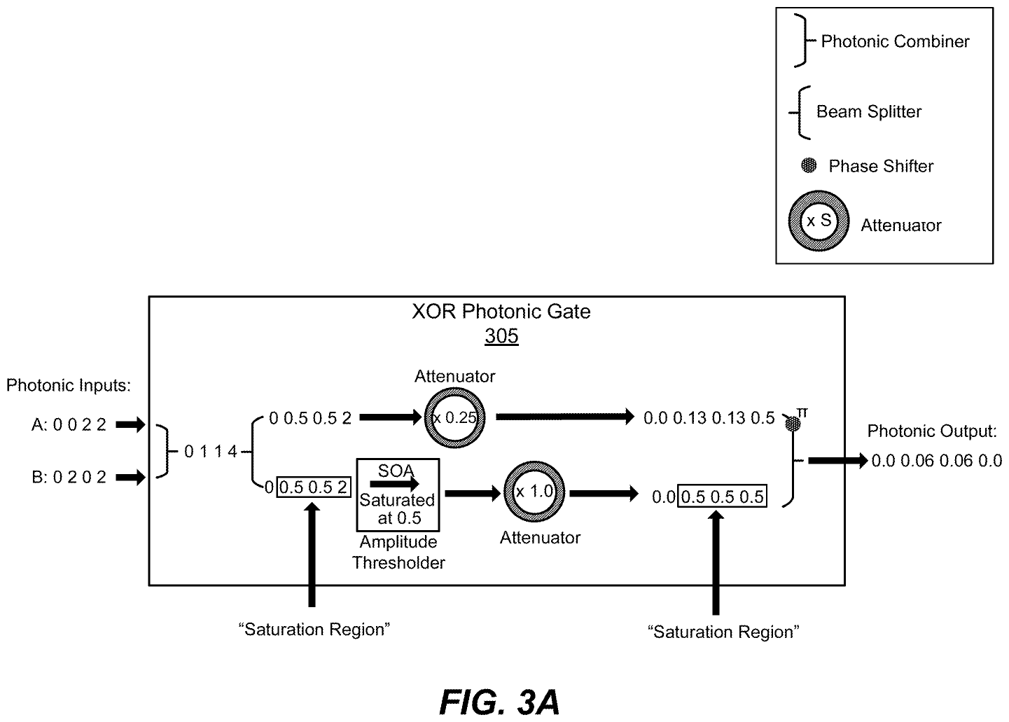

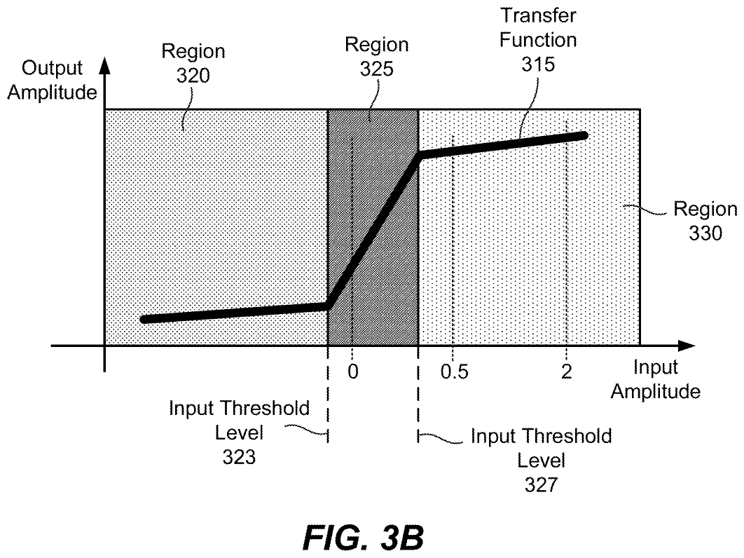

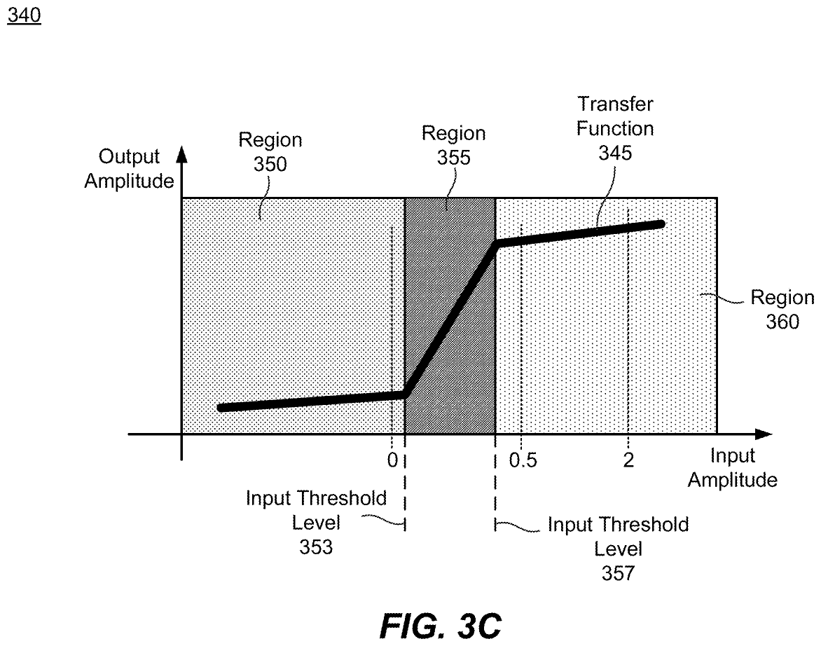

FIG. 3A illustrates an example XOR logic operation 300 of the photonic circuit 100, in accordance with some embodiments. An XOR photonic gate 305 shown in FIG. 3A represents an embodiment of the photonic circuit 100. The XOR photonic gate 305 receives a pair of photonic input signals A and B. The photonic input signals A and B may be light signals of corresponding input amplitudes (that correspond to logical “1” or logical “0”), corresponding input phases and/or corresponding input modes (i.e., input light spatial distribution and/or input wavelengths) injected into a set of input ports of a first photonic combiner of the XOR photonic gate 305 (e.g., the photonic combiner 106). For example, the photonic input signal A has a variable amplitude over time, having the amplitude sequence of “0 0 2 2” such that the photonic input signal A corresponds to the logical sequence of “0 0 1 1”; and the photonic input signal B has a variable amplitude over time having the amplitude sequence of “0 2 0 2” such that the photonic input signal B corresponds to the logical sequence of “0 1 0 1”. The photonic input signals A and B may represent examples of the photonic input signals 102 and 104.

The first photonic combiner of the XOR photonic gate 305 generates a photonic signal having an amplitude sequence of “0 1 1 4” by combining the photonic input signal A and the photonic input signal B. Note that the amplitude level of “1” corresponds to an amplitude level that is lower than the amplitude level of “2” but higher than the amplitude level of “0”; and the amplitude level of “4” corresponds to an amplitude level that is higher than the amplitude level of “2”. A beam splitter of the XOR photonic gate 305 (e.g., the beam splitter 110) splits the amplitude sequence of “0 1 1 4” into a pair of photonic signals, each having the amplitude sequence of “0 0.5 0.5 2”, where the amplitude level of “0.5” corresponds to an amplitude level that is higher than the amplitude level of “0” but lower than the amplitude level of “1”. A first photonic signal with the amplitude sequence of “0 0.5 0.5 2” generated by the beam splitter is attenuated (e.g., via the photonic attenuator/linear amplifier 116) by the scaling factor S of 0.25 to generate an attenuated photonic signal having the amplitude sequence of “0.0 0.13 0.13 0.5”. Note that the amplitude level of “0.13” corresponds to an amplitude level that is higher than the amplitude level of “0” but lower than the amplitude level of “0.5”.

A second photonic signal with the amplitude sequence of “0 0.5 0.5 2” generated by the beam splitter is input into a nonlinear amplitude thresholder of the XOR photonic gate 305 (e.g., the SOA-based amplitude thresholder 118). FIG. 3B illustrates an example graph 310 of a transfer function 315 of the nonlinear amplitude thresholder of the XOR photonic gate 305, in accordance with some embodiments. When the second photonic signal having the amplitude sequence of “0 0.5 0.5 2” is input to the nonlinear amplitude thresholder operating in accordance with the transfer function 315, the nonlinear amplitude thresholder generates a photonic signal having the amplitude sequence of “0.0 0.5 0.5 0.5”. The nonlinear amplitude thresholder operates in a region 330 of the transfer function 315 (e.g., “saturation region”) when the “input amplitude” is greater than an input threshold level 327. In such a case, the nonlinear amplitude thresholder saturates input amplitudes of “0.5” and “2” into output amplitudes that are approximately equal to “0.5”. When the “input amplitude” is smaller than the input threshold level 327 but greater than an input threshold level 323, an “output amplitude” is not saturated but instead processed by a transfer gain (i.e., slope) of a region 325 in which the nonlinear amplitude thresholder operates. In such a case, the input amplitude of “0.0” remains “0.0” at the output of the nonlinear amplitude thresholder. When the “input amplitude” is less than the input threshold level 323, the nonlinear amplitude thresholder may operate in a region 320 and may generate a saturated “output amplitude” that is smaller than “0.5”.

FIG. 3C illustrates another example graph 340 of a transfer function 345 of the nonlinear amplitude thresholder of the XOR photonic gate 305, in accordance with some embodiments. When the second photonic signal having the amplitude sequence of “0 0.5 0.5 2” is input to the nonlinear amplitude thresholder operating in accordance with the transfer function 345, the nonlinear amplitude thresholder generates a photonic signal having the amplitude sequence of “0.0 0.5 0.5 0.5”. The nonlinear amplitude thresholder operates in a region 360 of the transfer function 345 when the “input amplitude” is greater than an input threshold level 357 (e.g., “saturation region”). In such a case, the nonlinear amplitude thresholder saturates input amplitudes of “0.5” and “2” into output amplitudes that are approximately equal to “0.5”. When the “input amplitude” is less than an input threshold level 353, the nonlinear amplitude thresholder may operate in a region 350 (e.g., “another saturation region”) and may generate a saturated “output amplitude” that is equal to approximately “0.0”. When the “input amplitude” is smaller than the input threshold level 357 but greater than an input threshold level 353, an “output amplitude” may not be saturated but instead processed by a transfer gain (i.e., slope) of a region 355 in which the nonlinear amplitude thresholder would operate.

The photonic signal having the amplitude sequence of “0.0 0.5 0.5 0.5” generated by the nonlinear amplitude thresholder of the XOR photonic gate 305 may be attenuated (e.g., by the photonic attenuator 126) before being input to a second photonic combiner of the XOR photonic gate 305 (e.g., the photonic combiner 132). In the example 300 of FIG. 3A, the photonic signal having the amplitude sequence of “0.0 0.5 0.5 0.5” is not attenuated, e.g., the scaling factor S of 1.0 is applied. Before being input to the second photonic combiner of the XOR photonic gate 305, the attenuated photonic signal having the amplitude sequence of “0.0 0.13 0.13 0.5” is phase-shifted (e.g., via the phase shifter 124) by π radians to obtain a phase-shifted photonic signal having the amplitude sequence of “0.0-0.13-0.13-0.5”. Note that the amplitude level of “−0.5” refers to the amplitude level of “0.5” while having a shifted phase relative to the amplitude level of “0.5” by π radians; and the amplitude level of “−0.13” refers to the amplitude level of “0.13” while having a shifted phase relative to the amplitude level of “1.0” by π radians. The second photonic combiner of the XOR photonic gate 305 (e.g., the photonic combiner 132) combines the phase-shifted photonic signal having the amplitude sequence of “0.0-0.13-0.13-0.5” with the saturated (and, optionally, attenuated) photonic signal having the amplitude sequence of “0.0 0.5 0.5 0.5” to generate a photonic output signal having the amplitude sequence of “0.0 0.06 0.06 0.0”. Note that the amplitude level of “0.06” corresponds to an amplitude level that is higher than the amplitude level of “0” but lower than the amplitude level of “0.13”. Note also that operations of the second photonic combiner and the phase shifter are equivalent to subtracting the attenuated photonic signal having the amplitude sequence of “0.0 0.13 0.13 0.5” from the saturated photonic signal having the amplitude sequence of “0.0 0.5 0.5 0.5”.

As the amplitude level of “0.06” corresponds to the “high” logic value, the photonic output signal having the amplitude sequence of “0.0 0.06 0.06 0.0” corresponds to the logical sequence of “0 1 1 0”, which represents a correct result of the XOR logic operation between the photonic input signal A and the photonic input signal B. The photonic output signal having the amplitude sequence of “0.0 0.06 0.06 0.0” may be an example of the photonic output signal 134. It should be understood that example parameters of the XOR photonic gate 305 shown in FIG. 3A (e.g., phase shifting value, scaling factors of attenuators, and saturation level of the amplitude thresholder) represent one possible embodiment of the photonic circuit 100, and that other example parameters are possible that result in the XOR logic operation or some other logic operation of the photonic circuit 100.

The general mathematical model for the XOR photonic gate 305 can be derived using the notion of electric fields. The photonic input signal A can be defined as a sequence of electric field strengths over time, E₁¹, E₁², E₁³, E₁⁴; and the photonic input signal B can be defined as a sequence of electric field strengths over time, E₂¹, E₂², E₂³, E₂⁴, where {E₁³, E₁⁴, E₂², E₂⁴} >{E₁¹, E₁², E₂¹, E₂³}, and, ideally, E₁¹=E₂¹=0. The first photonic combiner of the XOR photonic gate 305 generates a combined photonic signal having a sequence of electric field strengths

$$\frac{{E}_{1}^{1} + {E}_{2}^{1}}{\sqrt{2}} , \frac{{E}_{1}^{2} + {E}_{2}^{2}}{\sqrt{2}} , \frac{{E}_{1}^{3} + {E}_{2}^{3}}{\sqrt{2}} , \frac{{E}_{1}^{4} + {E}_{2}^{4}}{\sqrt{2}}$$

by combining the photonic input signal A and the photonic input signal B. The beam splitter of the XOR photonic gate 305 splits the combined photonic signal into a pair of photonic signals, each having a sequence of electric field strengths

$$\frac{{E}_{1}^{1} + {E}_{2}^{1}}{2} , \frac{{E}_{1}^{2} + {E}_{2}^{2}}{2} , \frac{{E}_{1}^{3} + {E}_{2}^{3}}{2} , \frac{{E}_{1}^{4} + {E}_{2}^{4}}{2} .$$

Note that each value shown in FIG. 3A may represent a squared strength of a corresponding electric field which is proportional to an optical intensity.

The first photonic signal having the sequence of electric field strengths

$$\frac{{E}_{1}^{1} + {E}_{2}^{1}}{2} , \frac{{E}_{1}^{2} + {E}_{2}^{2}}{2} , \frac{{E}_{1}^{3} + {E}_{2}^{3}}{2} , \frac{{E}_{1}^{4} + {E}_{2}^{4}}{2}$$

is then attenuated (or amplified) by a factor A₁ to generate an attenuated/amplified photonic signal having a sequence of electric field strengths

$${A}_{1} ( \frac{{E}_{1}^{1} + {E}_{2}^{1}}{2} ) , {A}_{1} ( \frac{{E}_{1}^{2} + {E}_{2}^{2}}{2} ) , {A}_{1} ( \frac{{E}_{1}^{3} + {E}_{2}^{3}}{2} ) , {A}_{1} ( \frac{{E}_{1}^{4} + {E}_{2}^{4}}{2} ) .$$

The second photonic signal having the sequence of electric field strengths

$$\frac{{E}_{1}^{1} + {E}_{2}^{1}}{2} , \frac{{E}_{1}^{2} + {E}_{2}^{2}}{2} , \frac{{E}_{1}^{3} + {E}_{2}^{3}}{2} , \frac{{E}_{1}^{4} + {E}_{2}^{4}}{2}$$

is first saturated by a SOA-based amplitude thresholder that operates in a region of a transfer function that produces a saturated output strength of electric field equal to

$$\frac{{E}_{1}^{2} + {E}_{2}^{2}}{2} .$$

After that, the saturated photonic signal generated by the amplitude thresholder is attenuated by a factor A₂ to generate a saturated and attenuated photonic signal having a sequence of electric field strengths

$${A}_{2} ( \frac{{E}_{1}^{1} + {E}_{2}^{1}}{2} ) , {A}_{2} ( \frac{{E}_{1}^{1} + {E}_{2}^{1}}{2} ) , {A}_{2} ( \frac{{E}_{1}^{1} + {E}_{2}^{1}}{2} ) , {A}_{2} ( \frac{{E}_{1}^{2} + {E}_{2}^{2}}{2} ) .$$

The factors A₁ and A₂ may be set such that and

$${A}_{1} \frac{{E}_{1}^{4} + {E}_{2}^{4}}{2} = {A}_{2} \frac{{E}_{1}^{2} + {E}_{2}^{2}}{2} .$$

Furthermore, conditions that may be enforced are: E₁³=E₁⁴=E₂²=E₂⁴ and E₁¹=E₁²=E₂¹=E₂³.

The attenuated/amplified photonic signal having the sequence of electric field strengths

$${A}_{1} ( \frac{{E}_{1}^{1} + {E}_{2}^{1}}{2} ) , {A}_{1} ( \frac{{E}_{1}^{2} + {E}_{2}^{2}}{2} ) , {A}_{1} ( \frac{{E}_{1}^{3} + {E}_{2}^{3}}{2} ) , {A}_{1} ( \frac{{E}_{1}^{4} + {E}_{2}^{4}}{2} )$$

is phase-shifted by π radians before being input into the second photonic combiner of the XOR photonic gate 305. The second photonic combiner combines the phase-shifted attenuated/amplified photonic signal with the saturated and attenuated photonic signal to generate the photonic output signal having an ideal sequence of strengths of electric field 0,

$$( {A}_{2} - {A}_{1} ) \frac{{E}_{1}^{2} + {E}_{2}^{2}}{2 \sqrt{2}} , ( {A}_{2} - {A}_{1} ) \frac{{E}_{1}^{2} + {E}_{2}^{2}}{2 \sqrt{2}} , 0 ,$$

where the electric field intensity of

$$( {A}_{2} - {A}_{1} ) {\vert \frac{{E}_{1}^{2} + {E}_{2}^{2}}{2 \sqrt{2}} \vert}^{2}$$

corresponds to the high logic value when A₁<A₂. Thus, the generated photonic output signal corresponds to the XOR logic function between the photonic input signals A and B.

### Example Process Flow

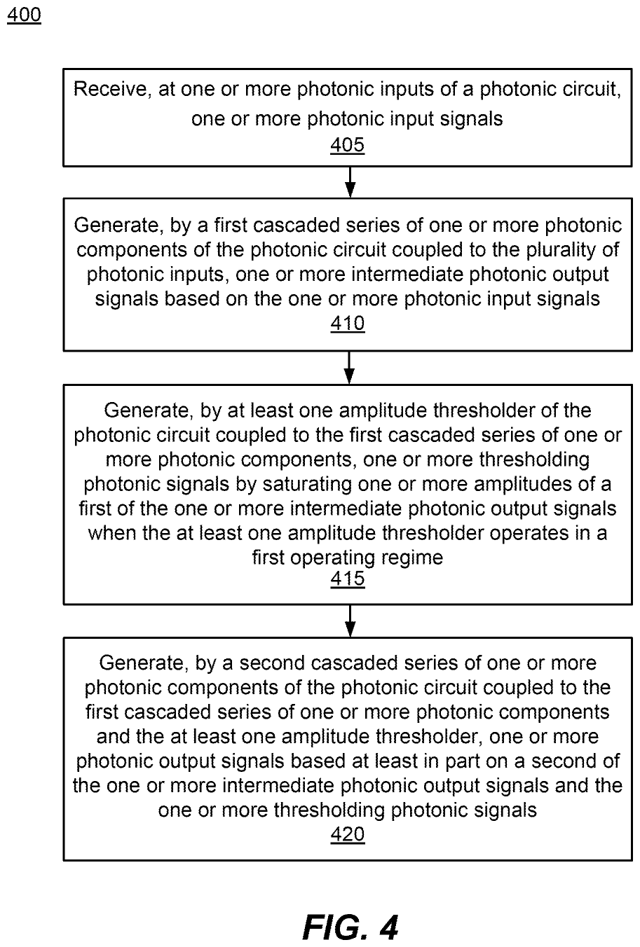

FIG. 4 is a flowchart illustrating an example method 400 for operating a photonic circuit with at least one nonlinear SOA-based amplitude thresholder for correction of amplitude and phase errors, in accordance with some embodiments. The operations of method 400 may be performed at, e.g., the photonic circuit 100. The photonic circuit may be part of a photonic processor that includes a cascaded connection of the photonic circuit and at least one other photonic component that includes the photonic circuit (e.g., cascaded connection of at least two photonic circuits). The photonic circuit may be deployed in a computing system (e.g., a photonic processor) that can further include a non-transitory computer-readable storage medium (e.g., optical, electrical, or electro-optical memory) for storing computer-executable instructions and data. The computing system may be an optical computing system (i.e., silicon photonics platform), an electronic computing system, some other type of computing system, or some combination thereof.

The photonic circuit receives 405, at one or more photonic inputs, one or more photonic input signals (e.g., two photonic input signals). The photonic circuit generates 410, by a first cascaded series of one or more photonic components coupled to the plurality of photonic inputs, one or more intermediate photonic output signals (e.g., the photonic signals 112, 114) based on the one or more photonic input signals. The first cascaded series of one or more photonic components may include a cascaded connection of a photonic combiner (e.g., the photonic combiner 106) and a beam splitter (e.g., the beam splitter 110).

The photonic circuit generates 415, by at least one amplitude thresholder (e.g., the SOA-based amplitude thresholder 118) coupled to the first cascaded series of one or more photonic components, one or more thresholding photonic signals by saturating one or more amplitudes of a first of the one or more intermediate photonic output signals (e.g., the photonic signal 114) when the at least one amplitude thresholder operates in a first operating regime. The at least one amplitude thresholder may be coupled to an output of the beam splitter (e.g., the beam splitter 110). The at least one amplitude thresholder may saturate one or more amplitudes of one or more photonic signals generated at an output of the beam splitter when generating the one or more thresholding photonic signals.

The at least one amplitude thresholder may be configured to saturate photonic signals of different amplitudes that are input in the at least one amplitude thresholder to a defined amplitude level. The at least one amplitude thresholder may be configured to generate the one or more thresholding photonic signals of the defined amplitude level when the first intermediate photonic output signal is greater than an input threshold value. The at least one amplitude thresholder may be configured to saturate the photonic signals of different amplitudes to the defined amplitude level of a plurality of amplitude saturation levels, each of the plurality of amplitude saturation levels associated with one or more different values of one or more parameters of a model of the at least one amplitude thresholder. The at least one amplitude thresholder may be configured to generate the one or more thresholding photonic signals by applying a transfer gain of the at least one amplitude thresholder to at least one amplitude of a first of the one or more intermediate photonic output signals when the at least one amplitude thresholder operates in a second operating regime.

The photonic circuit generates 420, by a second cascaded series of one or more photonic components coupled to the first cascaded series of one or more photonic components and the at least one amplitude thresholder, one or more photonic output signals based at least in part on a second of the one or more intermediate photonic output signals (e.g., the photonic signal 114) and the one or more thresholding photonic signals (e.g., the photonic signal 122). The second cascaded series of one or more photonic components may include a cascaded connection of a first photonic attenuator (e.g., the photonic attenuator/linear amplifier 116), a phase shifter (e.g., the phase shifter 124), a second photonic attenuator (e.g., the photonic attenuator 126) and a photonic combiner (e.g., the photonic combiner 132). The at least one amplitude thresholder may be coupled to an input of the second photonic attenuator. The second photonic attenuator may be configured to attenuate the one or more thresholding photonic signals generated by the at least one amplitude thresholder. The one or more photonic output signals may correspond to one or more outputs of an XOR function of the one or more photonic input signals.

Embodiments of the present disclosure are directed to a cascadable photonic circuit that utilizes at least one nonlinear photonic component (e.g., at least one SOA-based amplitude thresholder) for correction of errors (e.g., amplitude errors and/or phase errors) produced by linear photonic logic within the photonic circuit. The at least one nonlinear thresholder implemented as the at least one SOA-based amplitude thresholder can be configured to operate in different operating regimes and in accordance with different transfer functions, which provides additional flexibility in designing a cascadable photonic circuit that performs one or more specific logic operations. The photonic circuit presented herein produces correct output results and can be directly cascaded with other photonic circuits within a photonic processor.

### Additional Considerations

The disclosed configurations beneficially provide for efficient design of photonic logic gates while substantially reducing a number of required numerical design simulations.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to effectively convey the substance of their work to others skilled in the art. While described functionally, computationally, or logically, these operations are understood to be implemented by computer programs or equivalent electrical circuits, microcode, or the like. Furthermore, at times, it has also proven convenient to refer to these arrangements of operations as modules without loss of generality. The described operations and associated modules can be embodied in software, firmware, hardware, or some combination thereof.

Any steps, operations, or processes described herein can be performed or implemented with one or more hardware or software modules, alone or in combination with other devices. In one embodiment, a software module is implemented with a computer program product comprising a computer-readable medium containing computer program code, which a computer processor can execute for performing any or all of the steps, operations, or processes described herein.

Embodiments of the disclosure can also relate to an apparatus for performing the operations herein. This apparatus can be specially constructed for the required purposes, and/or it can comprise a general-purpose computing device selectively activated or reconfigured by a computer program stored in the computer. Such a computer program can be stored in a non-transitory, tangible computer-readable storage medium or any media suitable for storing electrical instructions coupled to a computer system bus. Furthermore, any computing systems referred to in the specification can include a single processor or architectures employing multiple processor designs for increased computing capability.

Some embodiments of the present disclosure can further relate to a system comprising a processor, at least one computer processor, and a non-transitory computer-readable storage medium. The storage medium can store computer-executable instructions, which, when executed by the compiler operating on at least one computer processor, cause at least one computer processor to be operable for performing the operations and techniques described herein.

Finally, the language used in the specification has been principally selected for readability and instructional purposes, and it has not been selected to delineate or circumscribe the inventive subject matter. It is therefore intended that the scope of the disclosure be limited not by this detailed description but rather by any claims that issue on an application based hereon. Accordingly, the disclosure of the embodiments is intended to be illustrative, but not to limit the scope of the disclosure, which is set forth in the following claims.

What is claimed is:

1. A photonic circuit, comprising:
a one or more photonic inputs configured to receive one or more photonic input signals;
a first cascaded series of one or more photonic components coupled to the one or more photonic inputs, the first cascaded series of one or more photonic components configured to generate one or more intermediate photonic output signals based on the one or more photonic input signals;
at least one amplitude thresholder coupled to the first cascaded series of one or more photonic components, the at least one amplitude thresholder configured to generate one or more thresholding photonic signals by saturating one or more amplitudes of a first of the one or more intermediate photonic output signals when the at least one amplitude thresholder operates in a first operating regime; and
a second cascaded series of one or more photonic components coupled to the first cascaded series of one or more photonic components and the at least one amplitude thresholder, the second cascaded series of one or more photonic components configured to generate one or more photonic outputs signal based at least in part on a second of the one or more intermediate photonic output signals and the one or more thresholding photonic signals.

2. The photonic circuit of claim 1, wherein the first cascaded series of one or more photonic components comprises a cascaded connection of a first photonic combiner and a beam splitter.

3. The photonic circuit of claim 2, wherein the at least one amplitude thresholder is coupled to an output of the beam splitter.

4. The photonic circuit of claim 1, wherein the second cascaded series of one or more photonic components comprises a cascaded connection of a first photonic attenuator, a phase shifter, a second photonic attenuator and a photonic combiner.

5. The photonic circuit of claim 4, wherein the at least one amplitude thresholder is coupled to an input of the second photonic attenuator.

6. The photonic circuit of claim 1, wherein the at least one amplitude thresholder is an active nonlinear semiconductor optical amplifier (SOA) based amplitude thresholder.

7. The photonic circuit of claim 1, wherein the at least one amplitude thresholder is configured to saturate photonic signals of different amplitudes that are input in the at least one amplitude thresholder to a defined amplitude level.

8. The photonic circuit of claim 7, wherein the at least one amplitude thresholder is configured to generate the one or more thresholding photonic signals of the defined amplitude level when the first intermediate photonic output signal is greater than an input threshold value.

9. The photonic circuit of claim 1, wherein the at least one amplitude thresholder is configured to generate the one or more thresholding photonic signals by applying a transfer gain of the at least one amplitude thresholder to at least one amplitude of a first of the one or more intermediate photonic output signals when the at least one amplitude thresholder operates in a second operating regime.

10. The photonic circuit of claim 1, wherein the one or more photonic output signals correspond to one or more outputs of an XOR function of the one or more photonic input signals.

11. The photonic circuit of claim 1, wherein the photonic circuit is part of a photonic processor comprising a cascaded connection of the photonic circuit and at least one other photonic component that includes the photonic circuit.

12. A non-transitory computer-readable storage medium comprising stored instructions that, when executed by at least one processor, cause the at least one processor to:
instruct one or more photonic inputs of a photonic circuit to receive one or more photonic input signals;
instruct a first cascaded series of one or more photonic components of the photonic circuit coupled to the one or more photonic inputs to generate one or more intermediate photonic output signals based on the one or more photonic input signals;
instruct at least one amplitude thresholder of the photonic circuit coupled to the first cascaded series of one or more photonic components to generate one or more thresholding photonic signals by saturating one or more amplitudes of a first of the one or more intermediate photonic output signals when the at least one amplitude thresholder operates in a first operating regime; and
instruct a second cascaded series of one or more photonic components of the photonic circuit coupled to the first cascaded series of one or more photonic components and the at least one amplitude thresholder to generate one or more photonic output signals based at least in part on a second of the one or more intermediate photonic output signals and the one or more thresholding photonic signals.

13. The computer-readable storage medium of claim 12, wherein the first cascaded series of one or more photonic components comprises a cascaded connection of a photonic combiner and a beam splitter, and the stored instructions comprise further stored instructions that, when executed, cause the at least one processor to:
instruct the at least one amplitude thresholder to saturate one or more amplitudes of a photonic signal generated at an output of the beam splitter to a defined amplitude level when generating the one or more thresholding photonic signals.

14. The computer-readable storage medium of claim 12, wherein the second cascaded series of one or more photonic components comprises a cascaded connection of a first photonic attenuator, a phase shifter, a second photonic attenuator and a photonic combiner, and the stored instructions comprise further stored instructions that, when executed, cause the at least one processor to:
instruct the second photonic attenuator to attenuate the one or more thresholding photonic signals generated by the at least one amplitude thresholder.

15. The computer-readable storage medium of claim 12, wherein the stored instructions comprise further stored instructions that, when executed, cause the at least one processor to:
configure the at least one amplitude thresholder to operate as an active nonlinear semiconductor optical amplifier (SOA) based amplitude thresholder.

16. The computer-readable storage medium of claim 12, wherein the stored instructions comprise further stored instructions that, when executed, cause the at least one processor to:
instruct the at least one amplitude thresholder to generate the one or more thresholding photonic signals by applying a transfer gain of the at least one amplitude thresholder to at least one amplitude of a first of the one or more intermediate photonic output signals when the at least one amplitude thresholder operates in a second operating regime.

17. The computer-readable storage medium of claim 12, wherein the stored instructions comprise further stored instructions that, when executed, cause the at least one processor to:
configure the at least one amplitude thresholder to saturate photonic signals of different amplitudes that are input in the at least one amplitude thresholder to a defined amplitude level.

18. The computer-readable storage medium of claim 17, wherein the stored instructions comprise further stored instructions that, when executed, cause the at least one processor to:
instruct the at least one amplitude thresholder to generate the one or more thresholding photonic signals of the defined amplitude level when the first intermediate photonic output signal is greater than an input threshold value.

19. The computer-readable storage medium of claim 17, wherein the stored instructions comprise further stored instructions that, when executed, cause the at least one processor to:
configure the at least one amplitude thresholder to saturate the photonic signals of different amplitudes to the defined amplitude level of a plurality of amplitude saturation levels, each of the plurality of amplitude saturation levels associated with one or more different values of one or more parameters of a model of the at least one amplitude thresholder.

20. A method comprising:
receiving, at one or more photonic inputs of a photonic circuit, one or more photonic input signals;
generating, by a first cascaded series of one or more photonic components of the photonic circuit coupled to the one or more photonic inputs, one or more intermediate photonic output signals based on the one or more photonic input signals;
generating, by at least one amplitude thresholder of the photonic circuit coupled to the first cascaded series of one or more photonic components, one or more thresholding photonic signals by saturating one or more amplitudes of a first of the one or more intermediate photonic output signals when the at least one amplitude thresholder operates in a first operating regime; and
generating, by a second cascaded series of one or more photonic components of the photonic circuit coupled to the first cascaded series of one or more photonic components and the at least one amplitude thresholder, one or more photonic output signals based at least in part on a second of the one or more intermediate photonic output signals and the one or more thresholding photonic signals.
